(19) United States
(12) Patent Application Publication
(10) Pub. No.: US 2005/0042431 A1
(43) Pub. Date: Feb. 24, 2005

(54) Multilayer plastics composite

(76) Inventor: Joachim Wagenblast, SAR Hongkong (CN)

Correspondence Address: BAYER MATERIAL SCIENCE LLC, 100 BAYER ROAD, PITTSBURGH, PA, 15205, US

(21) Appl. No.: 10/920,739

(22) Filed: Aug. 18, 2004

(30) Foreign Application Priority Data
Aug. 22, 2003 (DE) 10338589.4

(51) Int. Cl. B32B 7/02

(52) U.S. Cl. 428/216

(57) ABSTRACT

A multilayer plastics composite which includes at least three layers is described. More particularly, the multilayer plastics composite includes: (a) at least one layer of at least one thermoplastic polymer; (b) at least one layer of at least one elastomeric polymer; and (c) at least one layer of at least one thermoplastic polymer. Layer (b) is interposed between layers (a) and (c). Preferably, the multilayer plastics composite has a thermal expansion of 20×10⁻⁶ K⁻¹ to 40×10⁻⁶ K⁻¹.

### CROSS REFERENCE TO RELATED PATENT APPLICATION

The present patent application claims the right of priority under 35 U.S.C. §119 (a)-(d) of German Patent Application No. 103 38 589.4, filed Aug. 22, 2003.

### FIELD OF THE INVENTION

The invention relates to a multilayered plastics composite comprising a thermoplastic/elastomer composite, which can be used for example as an outer skin of a vehicle body, owing to the high impact strength at low temperatures, the low thermal expansion and smooth surfaces (Class A) of the multilayered plastics component.

### BACKGROUND OF THE INVENTION

In a conventional method of vehicle construction, outer skin parts such as, for example, mudguards, door panelling, side panelling or engine bonnets made of steel are typically used. Owing to its ductility, steel has very good impact strength and low thermal expansion even at low temperatures. Moreover, sheet steel can be manufactured with good surface qualities. The strict requirements for vehicle outer skins, such as splinter-free deformation in the event of a crash, small dimensional variations with temperature variations to ensure insignificant gaps between the individual outer skin parts and optical requirements relating to colour and gloss, can be met using steel. Outer skin parts made of plastics material are also used to reduce vehicle weight. In comparison with steel, plastics materials have a much lower density. Thus, outer skin parts made of plastics material help to reduce vehicle weight and fuel consumption.

However, these plastic outer skin parts used in practice typically have the disadvantage of much higher thermal expansion. Thermal expansion of typical unreinforced or unfilled plastics materials for car bodies lies between 70·10⁻⁶ and 110·10⁻⁶ K⁻¹. In comparison, the thermal expansion of steel lies at 10·10⁻⁶ K⁻¹. Moreover, the impact strength of plastics materials is extremely temperature-dependent. In the case of sudden mechanical stress, the transition from tough to brittle fracture behaviour for low temperature impact-resistant type plastics is −40 to −30° C. In contrast, temperature has practically no influence on the fracture behaviour of steel in vehicle applications.

If filler and/or reinforcing materials are used to reduce the thermal expansion of plastics materials, surface quality and impact strength are usually adversely affected. In order not to affect surface quality and impact strength too much, the content of filler and/or reinforcing materials is often limited to 10 to 20% by weight. This allows thermal expansion values of between 45·10⁻⁶ and 65·10⁻⁶ K⁻¹ to be achieved. Also, the transition from tough to brittle fracture behaviour is −20 to 0° C.

EP-A 0 422 358 describes a plastics composite of polyamide and rubber. This composite shaped material is designed to combine the properties of strength and rigidity with elasticity and slip resistance. A reduction in thermal expansion is not described. The disadvantage of this composite is that the polyamide is reinforced with fibrous fabric, so that no Class A surfaces can be achieved with this plastics composite.

### SUMMARY OF THE INVENTION

Thus, the object of the invention is to produce a plastics composite component which has low thermal expansion, viscoelastic deformation behaviour at low temperatures and when subjected to sudden stress and a Class A surface. In accordance with the present invention, there is provided a multilayer plastics composite comprising:
(a) at least one layer comprising at least one thermoplastic polymer;
(b) at least one layer comprising at least one elastomeric polymer; and
(c) at least one layer comprising at least one thermoplastic polymer, wherein layer (b) is interposed between layer (a) and layer (c).

Layers (a) and (c) may be the same or different relative to each other. Layer (b) is different from both layer (a) and layer (c). In particular, layers (a) and (c) may optionally contain no more than 40 percent by weight of elastomer; based on total weight of layers (a) or (c) respectively; and layer (b) contains at least 50 percent by weight of elastomer, based on total weight of layer (b).

Unless otherwise indicated, all numbers or expressions used in the specification and claims are understood as modified in all instances by the term “about.”

### DETAILED DESCRIPTION OF THE INVENTION

The plastics composite component according to the invention accordingly possesses two outer layers a) and c) made of thermoplastic polymer and an inner layer b) made of elastomeric polymer. The layers a) and c) can each be made up of a mixture of different thermoplastic polymers and layer b) of a mixture of different elastomeric polymers. Furthermore, layers a) and c) themselves can each consist of a plurality of layers of identical or different thermoplastic polymers and layer b) itself can consist of a plurality of layers of identical or different elastomeric polymers.

The thermoplastic polymer in layers a) and c) can be fibre-reinforced and/or mineral-filled and/or elastomer-modified. Examples of possible thermoplastic polymers are polyethylene terephthalate, polybutylene terephthalate, polyethylene terephthalate/polycarbonate, polyethylene terephthalate/acrylo-nitrile-styrene-acrylate, polybutylene terephthalate/polycarbonate, polybutylene terephthalate/acrylonitrile-styrene-acrylate, polycarbonate/acrylonitrile-styrene-acrylate, polycarbonate/acrylonitrile-butadiene-styrene, acrylonitrile-butadiene-styrene, polyamide and polypropylene. Examples of fillers and reinforcing materials are glass fibres, glass fabrics, glass mats, mineral materials, textile fibres, stretched plastics material fibres, metal fibres.

The thermoplastic polymer in layers a) and c) may contain up to 40 percent by weight of elastomer. Examples of possible elastomeric polymers for modification of layers a) and c) are thermoplastic polyurethane, chemically cross-linked elastomers, e.g. styrene butadiene rubber, butyl rubber, acrylonitrile rubber, ethylene vinyl acetate rubber, ethylene propylene rubber. Further examples are thermoplastic polyolefines, thermoplastic vulcanisate based on e.g. EPDM, thermoplastic elastomer based on styrene, e.g. styrene-ethylene-butadiene-styrene, on copolyamide or on copolyester.

In a preferred embodiment layers a) and c) show independently of each other a thickness of 0.2 to 2 mm.

Additionally preferably, stretched sheets of thermoplastic polymer are used for layer a) or c). For this the sheets are stretched along one or more main expansion directions of the plastics composite component (biaxial stretching below the crystallite melting temperature). This has the effect that the relaxation potential of the plastics materials counteracts the thermal expansion when the temperature is raised. The relaxation potential of the plastics materials is thus obtained from the release of the oriented molecule chains.

One example of possible elastomeric polymers for layer b) is thermoplastic polyurethane. Chemically cross-linked elastomers can also be used, e.g. styrene butadiene rubber, butyl rubber, acrylonitrile rubber, ethylene vinyl acetate rubber, ethylene propylene rubber.

The elastomer can be reinforced, e.g. with fibres or fabrics, and/or filled. The reinforcement and/or fillers help to further reduce thermal expansion and splintering susceptibility of relatively brittle thermoplastic topcoats, which may contain a higher proportion of fillers. If the elastomer layer b) is fabric-reinforced, this greatly increases the E modulus and the dimensional stability under heat compared to conventional components made of thermoplastic material. Plastics composite components with a fabric-reinforced elastomeric layer b) can also be used for horizontal components, for example engine bonnets, boot lids, car roofs, despite the fabric reinforcement. The bedding in of the fabric reinforcing material into the elastomeric middle layer between the thermoplastic outer layers a) and c) prevents the fabric structure from being copied on the surface of the composite component. Thus, the plastics composite components according to the invention can also fulfil the requirements of Class A surfaces.

The elastomeric layer b) can also be an adhesive film or sheet. In this case the elastomeric layer b) forms an adhesive bond to the thermoplastic layers a) and c). In so doing, the adhesive film or sheet b) is arranged between two thermoplastic layers a) and c) and heat-pressed to them to form a strong composite.

In a preferred embodiment layer b) has a thickness of 0.1 to 1 mm.

The sheets or films made of thermoplastic or elastomeric polymers for layers a) and c) and layer b) can be manufactured by known methods, e.g. by extrusion.

The manufacture and the shaping of the plastics composite built up in layers is carried out according to known methods. The manufacture of the plastics composite component according to the invention is carried out for example by arranging an adhesive film or sheet made from an elastomer as layer b) between two sheets made of thermoplastic polymer as layer a) and c) and by heat-pressing the layers to form a strong composite. Another manufacturing alternative is to bond layers a), b) and c) immediately after extrusion while still in a plastic state by means of sheet calibration and/or a rolling mill to form a strong composite, i.e. by pressing and/or calendering.

Generally, Class-A plastic surfaces are obtained by injection moulding, pressing or high pressure shaping processes with or without temperature changes. A Class-A surface for the plastics composite component according to the invention can be produced, for example, by thermoforming, film insert moulding, thermoform/press processes.

Thermoforming or cold forming using the high pressure method, for example, can be used for shaping the plastics composite in the production of components.

As well as the use of the plastics composite component according to the invention as a horizontally arranged outer skin part, the composite component can also be used as a vertically arranged outer skin part. Examples of these are car doors and side panelling, where low thermal expansion is particularly important.

Thus, the composite component is suitable both as a vertical and horizontal outer skin part for vehicle bodies with low thermal expansion, good cold impact strength and Class-A surface. Metal-free rigid and high-strength outer skin parts can be manufactured from the composite component. High-strength outer skin parts are those which have greater strength, rigidity and impact strength than outer skin parts conventionally composed of plastics parts. An advantage of the composite component according to the invention lies in the low thermal expansion. Low thermal expansion in the context of the present invention is considered to be in the range of 20 to 40·10⁻⁶ K⁻¹. Thus, thermal expansion is reduced by 12.5 to 200% compared to conventional pure thermoplastic outer skins. At the same time, the composite component has viscoelastic deformation behaviour at low temperatures, low temperatures in the context of the present invention being considered to be −10 to −30° C. The composite component shows, in particular, improved cold impact strength with a tough/brittle transition point shifted 10 to 20° C. lower.

The invention further relates to the use of the plastics composite component as vehicle body outer skin.

### EXAMPLES

Table 1 shows some examples of a plastics composite component according to the invention and its linear thermal expansion, impact strength at −20 to −30° C. In addition, the table indicates whether or not the outer thermoplastic layers a) and c) have a Class-A surface.

TABLE 1

| | | | Linear | Impact | |
|---|---|---|---|---|---|
| | | | thermal | strength | |
| | | | expansion | at −20/ | Class A |
| Layer a) | Layer b) | Layer c) | [10⁻⁶ K⁻¹] | −30° C. | surface |
| PC | ethylene vinyl | PC | 30-40 | tough/ | yes |
| stretched | acetate (EVA) | stretched | | brittle | |
| PC | EVA with fabric | PC | 40 | tough/ | yes |
| | reinforcement | | | tough- | |
| | | | | brittle | |
| PC | TPU with fabric | PC | 40 | tough/ | yes |
| | reinforcement | | | tough | |
| PC/ | EVA with uni- | PC/ | 40 | brittle/ | yes |
| PET20M | directional fibre | PET20M | | brittle | |
| | reinforcement | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A multilayer plastics composite comprising:
(a) at least one layer comprising at least one thermoplastic polymer;
(b) at least one layer comprising at least one elastomeric polymer; and
(c) at least one layer comprising at least one thermoplastic polymer, wherein layer (b) is interposed between layer (a) and layer (c).

2. The multilayer plastics composite of claim 1 wherein layer (a) and layer (c) each independently have a thickness of 0.2 to 2 mm.

3. The multilayer plastics composite of claim 1 wherein layer (b) has a thickness of 0.1 to 1 mm.

4. The multilayer plastics composite of claim 1 wherein layer (a) and layer (c) each comprise a polymer selected independently from the group consisting of polyethylene terephthalate, polybutylene terephthalate, polyethylene terephthalate/polycarbonate, polyethylene terephthalate/acrylonitrile-styrene-acrylate, polybutylene terephthalate/polycarbonate, polybutylene terephthalate/acrylonitrile-styrene-acrylate, polycarbonate/acrylonitrile-styrene-acrylate, polycarbonate/acrylonitrile-butadiene-styrene, acrylonitrile-butadiene-styrene, polyamide, polypropylene and combinations thereof.

5. The multilayer plastics composite of claim 4 wherein layer (a) and layer (c) each further comprise a material selected independently from the group consisting of fiber reinforcement material, mineral filler material, elastomer material and combinations thereof.

6. The multilayer plastics composite of claim 1 wherein layer (b) comprises a thermoplastic material selected from the group consisting of polyurethane, styrene butadiene rubber, butyl rubber, acrylonitrile rubber, ethylene vinyl acetate rubber, ethylene propylene rubber and combinations thereof.

7. The multilayer plastics composite of claim 6 wherein layer (b) further comprises a material selected from the group consisting of mineral filler material, reinforcement material and combinations thereof.

8. The multilayer plastics composite of claim 1 wherein at least one of layer (a) and layer (c) comprises a stretched sheet of thermoplastic material.

9. The multilayer plastics composite of claim 1 wherein said multilayer plastics composite is a vehicle body outer skin.

10. The multilayer plastics composite of claim 1 wherein said multilayer plastics composite has a thermal expansion of 20×10⁻⁶ K⁻¹ to 40×10⁻⁶ K⁻¹.
